(19) United States
(12) Patent Application Publication
(10) Pub. No.: US 2005/0000903 A1
(43) Pub. Date: Jan. 6, 2005

(54) Method for land improvement and microorganisms therefor

(76) Inventors: Imre Mecs, Szeged (HU); Miklos Kalman, Zsombo (HU); Miklos Hlatki, Szolpok (HU); Sandor Puskas, Szeged (HU); Janos Balazs, Szeged (HU); Gyula Lengyel, Szeged (HU); Zsolt Virag, Oroshaza (HU); Gyula Kovacs, Oroshaza (HU); Ferenc Horvath, Oroshaza (HU); Imre Samu, Oroshaza (HU)

Correspondence Address: WELSH & KATZ, LTD, 120 S RIVERSIDE PLAZA, 22ND FLOOR, CHICAGO, IL, 60606, US

(21) Appl. No.: 10/492,233

(22) PCT Filed: Oct. 8, 2002
(86) PCT No.: PCT/HU02/00103

(30) Foreign Application Priority Data
Oct. 8, 2001 (HU) P 0104154
Oct. 7, 2002 (HU) P 0203394

(51) Int. Cl. C02F 1/42

(52) U.S. Cl. 210/683

(57) ABSTRACT

The invention relates to methods for land improvement (soil reclamation), preferably for soil remediation comprising the steps of (i) placing a material useful for improving soil, and an explosive in the soil, and (ii) mixing the materials useful for reclaiming the soil and the polluted soil by explosion. The invention also relates to methods methods for providing microorganisms useful for decomposing hydrophobic pollutants, mineral oil components and derivatives by selection and isolation from soil, the microorganisms, their uses and kits for land improvement and soil remediation. The invention is useful in particular for remediation of soil polluted with oil components and derivatives.

### CROSS-REFERENCE TO RELATED APPLICATIONS

This is a U.S. National Stage filed under 35 U.S.C. § 371 which claims the benefit of priority to International Patent Application No. PCT/HU02/00103 filed Oct. 8, 2002, which claims the benefit of priority to Hungarian Patent Application No. P0203394 filed Oct. 7, 2002 and Hungarian Patent Application No. P0104154 filed Oct. 8, 2001, the disclosures of which are incorporated herein in full by reference.

### DESCRIPTION

The invention relates to land improvement by mixing the soil and materials useful for reclaiming it using explosion. Preferably the invention relates to methods for reducing the extent of soil pollution by using microorganisms selected for this purpose. The invention also relates to methods for providing the microorganisms in an isolated form, the microorganisms themselves, their uses and kits for land improvement and soil remediation.

The method for soil remediation preferably comprises placing in the polluted soil or close to it, below the surface of the soil, microorganisms useful for decomposing or inactivating at least one kind of material, said microorganisms being effective both in aerobic and anaerobic conditions, and an explosive and mixing the polluted soil, the microorganisms and, optionally, additives for improving living conditions of microorganisms by explosion, and allowing the microorganisms to act in the soil.

The polluted soil in most cases is cleansed with living organisms, usually microorganisms useful for that purpose (1, 2).

Effective bioremediation with microorganisms can be achieved if microorganisms (11) resistant to the certain pollutant and capable of decomposing it, are used in their required growth conditions (temperature, moisture, oxygen concentration, nutrition etc.). Thus, it is important to add additives which influence the microorganisms' function and the effectiveness of bioremediation to their advantage (for example micro and macro elements, carbon, nitrogen, phosphorous, sulphur, Mn, etc.) (11).

It is important to disperse or spread the essential additives and the microorganisms used in bioremediation in the polluted medium. Several solutions to this problem exist up to date.

In case of soils, traditionally the additives and microorganisms administered to the surface are filtered (using gravity), injected or mixed into the soil. (5, 6) These technologies provide inadequate mixing, or the required distribution of materials in the polluted soil develop only very slowly. In addition the process is hardly controllable.

In another method used in practice regularly the acquired polluted soil is mixed with materials promoting its decomposition, then this mixture is brought back to the field (prismatic technology). This method is quite expensive, especially in case of larger areas or in case of cleansing low-lying pollutions.

The invention is based on the unexpected finding that the above-mentioned problems can be economically and effectively solved by mixing the soil and microorganisms chosen for the given purpose (and, preferably, further additives) applying explosion. The novel method was named bio-explosion.

According to the art there are microorganisms known for decomposing various pollutants, mineral oil components or derivatives and methods for selecting these, wherein the principle of said methods is that microorganisms are supplied with the material to be decomposed as the only carbon source. To the best of our knowledge tenside producing ability of the microorganisms was not examined.

Such microorganism are e.g. those which are commercialized by Oil Cleaning Bio-Products Ltd. P.O.Box 46, Royston, Hertfordshire SG8 9PD U.K., e.g. Hegrem and Hegboost products (e.g. the enclosed product descriptions).

However, a need for advantageous selection methods, which lead to effective microorganisms with a high reliability and which include clear selection criteria, still exists.

### DEFINIIONS

The term “soil” includes the whole depth of the soil from the surface layers (A-level or humus level) to the deepest layer in contact with the parent material or the impermeable layer (e.g. geologic level or D-level).

The phrase that holes are arranged “essentially alternately” relates to an arrangement of holes according to which no holes with identical filling can be found in the vicinity of each other in a large number, preferably at most 5 or more preferably at most 3 holes with an identical filling can be found in the vicinity of each other. Preferably, in the major part of the area with holes the holes are alternating according to a simple mathematical rule, e.g. no holes with an identical filling can be found in the vicinity of each other.

The term “essentially regular distances” is used herein in connection with an arrangement of holes according to which on a given part of the area comprising holes the distance of holes from each other is essentially identical i.e. the distances vary in at most 50%, 40%, 30%, 20%, highly preferably in at most 10 or 5%, at least in one direction, preferably in all directions in the plane.

A “mineral oil component” is meant herein as any component, fraction or any mixture thereof of the raw mineral oil.

A “mineral oil derivative” is meant herein as any artificially preparable derivative of the mineral oil or any component thereof, or a derivative produced in a non-geological process.

“Tenside” means any surfactant.

The term “microorganism” is meant herein as living organism, either of mono or multicellular structure or without and cellular structure, preferably monocellular organisms, which belong to the scope of microbiology. “Microorganisms” are preferably algae, in particular blue algae; bacteria and fungi.

A “microorganism strain” is a pure culture of microorganisms started from a single cell, preferably a culture of a given species maintained or maintainable by regular subculturing.

### BRIEF DESCRIPTION OF THE INVENTION

Thus, in an aspect the invention relates to a process for improving quality of soil said process comprising the steps of
(i) placing
a material useful for improving soil, and
an explosive
in the soil, and
(ii) mixing the materials useful for improving (reclaiming) soil and the polluted soil by explosion.

Preferably, by the process of the invention the degree of the pollution is decreased by
(i) placing in the polluted soil or close to it, below the surface of the soil
microorganisms useful for decomposing or inactivating at least one kind of material, which are, if desired, resistant to said material,
an explosive and
preferably
additive materials improving living conditions of microorganisms and/or facilitating their propagation and/or soil-improving function,
(ii) mixing the polluted soil and the placed materials and microorganisms by explosion,
(iii) allowing the microorganisms to act in the soil.

Preferably the microorganisms, explosive and optionally further materials are placed in holes bored in soil, preferably at a distance of 0.5 to 5 m, preferably 1.5 to 2 m from each other and preferably the microorganisms and the explosive are placed in separate holes. Holes containing explosive and holes not containing it can be located e.g. essentially alternately and preferably at essentially regular distances, more preferably in rows, even more preferably arranged according to a geometric network.

Preferably, after the explosion additives improving living conditions of the microorganisms and/or facilitating decomposition are introduced into the soil, for instance by aeration, infiltration or injection. As preferred additives one or more of the following are applied:
compounds promoting anoxic respiration, preferably redox systems and/or electron acceptors and/or hydrogen acceptors, more preferably compounds of metals with more than one oxidation state and/or nitrite-, nitrate-, chlorite-, chlorate-, perchlorate-, phosphate-, pyrophosphate-, sulphite-, sulphate-, pyrosulphate-ions or their salts.
metal ions, trace elements enhancing enzyme activity, in particular Fe-, Cu-, Ni-, Co-, Mn-, Mg-, Zn-, or Ca-ions,
carbon sources, preferably glucose, sacharose, molasses, glycerol, acetate, xantane,
nitrogen sources, preferably peptone, nitrite, nitrate, ammonium ions or their salts,
phosphorous sources, preferably phosphate, pyrophosphate ions or their salts,
sulphur sources: sulphate, pyrosulphate ions or their salts,
tensides and/or surfactants, preferably Tween 20, Tween 40, Tween 60, Tween 80, nonite, DMSO,
compounds promoting adhesion to surface which are preferably biologically degradable, xantane.

The strength of explosion is preferably set to a value which results in the damage of at most a small part of microorganism, more preferably in no damage and no uncovering of the microorganisms.

According to a highly preferred embodiment the pollutant is a mineral oil component or derivative.

In a further aspect the invention relates to a process for preparing a microorganism in an isolated form, said microorganism being useful for decomposing a hydrophobic pollutant, mineral oil component or derivative and capable of exerting its decomposing activity at the boundary of the hydrophobic phase comprising the said hydrophobic pollutant, mineral oil component or derivative and a hydrophilic phase, the process comprising the steps of
i) applying a film comprising the mineral oil component or derivative to a minimal medium lacking carbon source,
ii) inoculating this medium with a sample comprising a mixture of microorganisms said sample being obtained from an oil pollution, and incubating the medium after inoculation at least until detectable microorganism colonies are formed,
if the formation of colonies does not occur within an arbitrarily defined time period step i) and present step ii) are repeated,
iii) decomposing activities of the microorganism from the colonies formed are tested at the surround of the colonies and
iv) tenside producing abilities of the decomposing microorganisms obtained from the colonies are checked and a tenside producing microorganism is selected.

Preferably, the microorganism is a facultative anaerobe which is obtained by using minimal medium comprising materials facilitating anoxic respiration, preferably electron acceptors and/or oxygen sources—in particular one or more of the following: Ti-compounds, Mn-compounds, nitrite, nitrate, phosphate, pyrophosphate ions or their salts, and preferably the incubation is carried out at least partly under anaerobic conditions.

In a preferred embodiment decomposing activity is assessed by assaying the pollutant concentration of samples taken from the close surrounding/immediate vicinity of the colonies and/or on the basis of the diameter of the decomposed area.

As a decomposing activity e.g. paraffin decomposing activity can be assayed or an enzyme activity for decomposing typical mineral oil pollutions, preferably by sampling, solvent extraction then by gas chromatography. Tenside producing ability of the microorganisms from the colonies obtained can be studied by e.g. a hydrophobic-hydrophilic drop test.

In a further aspect, the invention relates to a microorganism useful for decomposing a mineral oil component or derivative, capable of exerting its decomposing activity at the boundary of the hydrophobic phase comprising the said hydrophobic pollutant, mineral oil component or derivative and a hydrophilic phase, said microorganism producing at least one enzyme capable of decomposing the mineral oil component or derivative, and at least one tenside.

Preferably the microorganism is a strain belonging to the Bacillus subtilis species, the Bacillus cereus species, the Pseudomonas genus or the Xanthomonas genus and is, preferably, a facultative anaerobe.

Highly preferably the oil-pollutant decomposing activity of the microorganism, detected by culturing on a polluted medium on any of the following oil-pollutants: hydrophobic deposit, asphaltene, maltene, 5% asphaltene plus oil, is at least 1.2 times, preferably 1.5 or 2 times, highly preferably 3 times larger, as an average, than that of the Hegrem or Hegboost microorganism.

The invention relates to microorganisms obtainable by the process of the invention, preferably any of the following strains deposited on Apr. 17, 2002 at the NCAIM: NCAIM (P) B 1304, NCAIM (P) B 1305, NCAIM (P) B 1306, NCAIM (P) B 1307, NCAIM (P) B 1308, or any strain derived therefrom.

The microorganism may be genetically modified, preferably may carry, incorporated into their genome, a DNA fragment of a known sequence.

In a further aspect the invention relates to the use of a microorganism of the invention for decomposing a soil pollution caused by a mineral oil component or derivative.

In a further aspect the invention relates to a kit for soil remediation or land improvement (soil reclamation) comprising an information carrier with users instructions which comprise instructions for carrying out any of the steps of any of the processes of claims 1 to 8 and said kit further comprising at least one kind of material applicable in any of the processes of claims 1 to 8.

The kit comprises preferably a microorganism according to the invention, and more preferably further comprises on or more of the following group: explosives, aids to blasting, additives to ensure living conditions or helping microorganisms or increasing the effect thereof. Highly preferably the kit comprises one or more kind of the above-defined additives.

### BRIEF DESCRIPTION OF THE FIGURES

In FIG. 1, colonies of isolated bacteria can be seen streaked (inoculated) on a thin film of pollutant in three Petri-dishes. It can be observed that the pollutants are decomposed or converted surrounding the colonies. This can be seen as clearing or discoloration around the colonies. Whether we want to characterize the activity of decomposition, we can measure the width (diameter) of the cleared up (discolored) band.

In FIG. 2 the ability of the acquired microorganism strains (phyla) to produce tensides is examined. With the hydrophilic—hydrophobic drop test one can observe the difference between spreading and non-wetting drops.

FIG. 3 shows the effect of several microorganism strains—described using chromatography—on the hydrocarbon content of the paraffin sample (for V. see FIG. 3a, for II. see FIG. 3b) after one week of incubation. In the bar chart the ratio (expressed in percentage) the area below the curve characteristic of the undecomposed sample can be seen in the ratio of the area below the curve of the whole undecomposed mass. The marks on the horizontal axis mean the following microorganism strains.

| | | |
|---|---|---|
| Ref I | Hegrem* | |
| Ref II | Hegboost* | |
| A | MOL-2 | NCAIM (P) B 1304 |
| B | MOL-32 | NCAIM (P) B 1305 |
| C | MOL-51 | NCAIM (P) B 1306 |
| D | MOL-66 | NCAIM (P) B 1307 |
| E | MOL-107 | NCAIM (P) B 1308 |
| F | MOL-113 | A Pseudomonas sp. strain |
| | | isolated by the inventors |

*commercialized by Oil Cleaning Bio-Products Ltd. P.O.Box 46, Royston, Hertfordshire SG8 9PD U.K., see also the product descriptions and the home page: www.ocbp.co.uk.

In FIGS. 4.a and 4.b, a possible concrete arrangement of the holes bored in the soil is shown. Microorganisms can be placed in the same or in different holes.

In FIG. 5.a we can see the decrease in pollutants in the soil expressed in percentage, as a function of time. In FIG. 5.b the steps of inland experiments can be seen.

### DETAILED DESCRIPTION OF THE INVENTION

Below by non-limiting examples, some embodiments of the invention are described, for example:
(i) conditions of the blast, materials and measures advantageously affecting living conditions of the microorganisms in the blasted soil and
(ii) selection method used for selecting microorganisms useful for soil bioremediation and the properties of preferred microorganisms.
(i) The soil treated by bio-explosion is highly scarified (mellowed) due to the intervention. The strength of the blast can be determined depending on the structure of the soil, on the concentration of the pollutant and its location in depth calculated from the surface and on the area of the pollution. It is expedient to aim at fully mixing the microorganisms and the materials ensuring or enhancing their vital functions (the “additives”) with the polluted soil, while avoiding that the components get to the surface of the soil. To that purpose a blast of calculated strength and, by all means, a moderate strength is needed.

In most cases it is expected to be preferred if microorganism and additives are evenly spread and also the strength of the explosion is possibly evenly distributed. Of course, if the quality of the soil or the distribution of the pollutant in not homogenous, other aspects are to be considered.

Thus, in the process of the invention the microorganism, the explosive and optionally further materials are placed in holes bored in the soil which are found at a distance of 0.5 to 5 m, preferably 1 to 3 m, more preferably 1.5 to 2 m from each other. By the distance of the holes and the quantity of the microorganisms the effectness of the bioremediation can be controlled as required by the pollutant.

Microorganisms, explosive and, if desired, additives can be placed in the same hole (in such cases expediently the explosive is placed below) provided that at the site of the explosion a sufficient quantity of microorganisms survive so that the desired remediation effect could be achieved. (In certain cases a protective layer can be applied to protect microorganisms.) More preferably the explosive and the microorganism(s) [if desired, together with the additive(s)] can be placed in separate holes. Highly preferably the explosive, the microorganisms and the additives are each placed in separate holes.

The depth of the holes, the geometry of the microorganisms, additives and the explosive in them and the strength of the explosion is set so that a damage, at least a damage larger than necessary, and getting the materials to the surface could be avoided (see Example 5). A preferred explosion is in most cases relatively mild.

In a preferred embodiment the holes are placed at essentially regular distances, preferably according to an essentially regular geometry, e.g. in rows and/or in columns. Highly preferably the holes comprising and not comprising explosive are arranged essentially alternately. For example, if holes with two types of filling (e.g. microorganism and explosive) are applied a checkerboard pattern, if three types (e.g. microorganism, explosive and additive), a triangulated pattern is preferred.

Blasting can be carried out even in the groundwater, below the groundwater surface if the blasting material is rendered waterproof, or it is not water sensitive. For example it can be placed in plastic vials or sacks, e.g. in thin, long hoses which also keep water away from the initiator explosive and the blasting fuse. The material can be PVC or any appropriate plastic foil.

Depth of explosion and the area to be exploded are defined by the localization of the pollution (or the soil to be reclaimed). If desired blasting can be carried out at arbitrary depth, i.e. not only surface layers of the soil but its deeper layers, expediently to the first impermeable layer, can be treated. With microorganism surviving under anoxic conditions remediation can be carried out in deep layers of the soil, this way.

Thus, preferred explosives are those blasting materials which do not have an expressly high explosion rate but which do not or only slightly damage microorganisms. This effect, of course, depends also on the arrangement of holes and materials therein. The explosion rate of a preferred blasting material results in, besides destructive effect, a significant if not dominant pushing effect (slow-action explosives). Thus, explosives used in mining are preferred. Explosion rate is preferably less than 7000 m/s, preferably less than 6000 m/s, preferably less than 5000 m/s, but at the same time larger than 500 or 1000 m/s, more preferably larger than 2000 or 3000 m/s, e.g. 3500 to 4000 m/s. As a matter-of-course, effect and strength of the explosion, besides explosion rate, is a function of the said geometry and the quantity of the explosive, and is affected by other properties of the explosives e.g. explosion heat, specific gas volume, specific pressure etc. Selection of an explosive with appropriate parameters to the given task and determination of the desired arrangement is routine for a skilled person.

It is preferred if the material of the explosive, after explosion, results in compounds not detrimental to the soil and the microorganisms (not toxic), and preferably useful compounds are formed. Such explosives are e.g. those comprising nitrate ion or group, e.g. NH₄NO₃ comprising explosives, e.g. paxit.

Taken together, a person skilled in pyrotechnics can easily decide on the conditions and necessary strength of the blasting, on the basis of the present teaching.

If desired, as a next step we may apply after-treatment. This can be for example aeration, infiltration, injection, or steaming.

Aeration is in order if for instance the microorganisms are aerobic, or the conditions in the soil are such that oxygen is essential. The fissures and cracks generated with detonation may not be sufficient to provide the necessary oxygen. In this case oxygen is pumped into the soil subsequently, for instance by placing a perforated tube in the soil. The air is pumped in using a compressor.

This is especially important if no cracks arise in the soil or they disappear quickly, for instance if the ground is loose, like sand or moist soil. Subsequent aeration is also advisable if the pollution is in the lower layers of the earth, and the detonation takes place there.

After the detonation it can be useful to administer active agents preferably by infiltration or injection into the soil to improve the living conditions of the microorganisms and/or to promote decomposition, such as by addition of dilute solutions of nitrate, sulphate, or phosphate. This can be important in cases where the soil has depleted its sources of these compounds or during detonation the compounds introduced into the ground aren't sufficient. Subsequent improvement of the soil is important in other aspects, we can add compounds that are favored by the microorganisms.

If appropriate amount of fissures and cracks were generated in the ground, infiltration can be a right choice for additional treatment. Otherwise injection is in order, which can be performed with a perforated tube.

The moisture and/or temperature of the soil can be improved by steaming.

The method of the invention can be used simply for the improvement of the ground. In this case the explosives along with the soil-improving agents are placed in the ground and detonated as aforementioned.

The bioexplosion technology can be used for all biologically decomposable pollutants. And for this all microorganisms can be used that can decompose and/or inactivate pollutants effectively. This procedure is versatile. Such microorganisms are well known, and many more will be isolated in the years to come. The technology can be used with them, as well.

The microorganisms used for decomposition of the pollutants can be isolated from the environment, preferably from the polluted soil, or we can use the commercially acquirable ones, or the genetically improved, previously mentioned strains (3, 4).

Of course it is advantageous if the microorganism used is resistant to the pollutant (7), and if they are able to produce surfactants or enzymes capable of decomposition, or preferably both.

Considering their oxygen need we can distinguish aerobic, anaerobic, or facultative anaerobic microorganisms (11). Whether we consider the temperature tolerance of the microorganisms used, we can talk about the ones that prefer cold (psychrophilic), the ones that prefer medium temperature (mesophilic), or the ones that prefer temperature above normal (thermophilic). In bioremediation mesophilic-aerobic, thermophilic-anaerobic, and facultative anaerobic microorganisms exceed the others in effectiveness and rentability.

In certain cases there can be a demand that the microorganisms used for bioremediation be apathogenic (1, 2), in other words they shouldn't cause neither plant, nor animal, nor human diseases. In other cases even microorganisms capable of causing diseases can be used, if later on they die or if they have no effect on humans, thus can be used as a pesticide or herbicide at the same time.

Microorganisms can be genetically enhanced, favorably carrying DNA fragment—of which the sequence is known—ligated into its' genomes as a marker.

To achieve effective bioremediation the life circumstances can be improved: by setting temperature, moisture, oxygen concentration, or by adding additives like nutrition, macro and microelements (compounds containing carbon, nitrogen, phosphorous, sulphur, etc.). (11) (see below)

The activity of bioremediation of the microorganisms can be improved with tensides administered to the polluted water or contaminated soil in case of hydrophobic or badly soluble pollutants. (8, 9)

In anaerobic conditions (for instance lower layers of the earth or wet soil) the activity of facultative anaerobic microorganisms can be insured with electron acceptors and hydrogen acceptors—which allow anoxic respiration—such as nitrite (NO₂⁻), nitrate (NO₃⁻), phosphate (PO₄³⁻) or sulphate (SO₄²⁻) salts. (10)

Other additives promoting anoxic respiration, (NO₂, NO₃, PO₃, P0₄, P₂O₄, P₂O₇, ClO₂, ClO₃, ClO₄, BO₄, B₂O₇) even their inorganic salts or even organ be used.

A favorable solution would be to add electron acceptor additives which catalyse inorganic respiration such as metal ions and their salts, preferably Zn ions or Ti2+ions for instance in the form of TiCl₂ salt.

Choosing the additives we have to take the quality of the soil and its composition into consideration. For example the anions that contain N and P are rare, while the ones that contain S (SO₄²⁻) and cations such as K⁺ and Ca²⁺ aren't. It is also important to provide ions for the bacteria, which though rare to be found in the soil are vital for the catalytic function of enzymes, for instance Mn-, Mo-, Ti- and Zn-ions.

Microorganisms can be exploded along with an organic C source (for example: glucose, sacharose, molasses, acetate salts, glycerol).

Several of the additives, which improve the microorganisms' function and decomposition activity—used during the bioexplosions—are summarized according to function in Table 1 below.

TABLE 1
Compounds promoting anoxic respiration: preferably redox systems and/or electron
acceptors and/or hydrogen acceptors, suitably compounds of metals with more oxidative state
(for example: Fe, Cu, Ti, Mn, or Mo - ions or manganates and/or molybdenates), also nitrite-,
nitrate-, chlorite-, chlorate-, perchlorate-, phosphate-, pyrophosphate-, sulphite-, sulphate-,
pyrosulphate-ions or their salts.
Metal ions, trace elements enhancing enzyme activity: suitably Fe—, Cu—, Ni—, Co—, Mn—,
Mg—, Zn—, or Ca— ions, preferably Mn²⁺, Mg²⁺, Zn²⁺ and Ca²⁺.
Carbon sources: preferably glucose, saccharose, molasses, glycerol, acetate, xantane.
Nitrogen sources: suitably peptone, nitrite, nitrate, ammonium ions or their salts.
Phosphorous sources: preferably phosphate, pyrophosphate ions or their salts.
Sulphur sources: sulphate, pyrosulphate ions or their salts.
Tensides and/or surfactants: mainly Tween 20, Tween 40, Tween 60, Tween 80, nonite,
DMSO.
Compounds promoting adhesion to surface: preferably all natural or synthetic polymers for
instance poly-acrilamide, poly-vinylpolymer, more preferably biologically decomposable
polymers such as hydrocolloids, highly preferably xantane.

The additives in the concentrations that are used aren't toxic. For example the diluted solution of DMSO (dimethyl-sulphoxide) up to 20% isn't toxic.

Organic additives are environment friendly and decompose over time.

These additives can be partially added to the soil subsequently, after the detonation. The loose structure of the soil after the bioexplosion helps the process.

Frequent pollutants purification with bioexplosion:

all paraffins asphaltenes, hydrocarbons containing maltene.
polyaromatic hydrocarbons, phenol, phenol derivatives
automobile, airplane fuels
halogenated hydrocarbons or their derivatives with sulphur substitution (dichlorophenol, benzthiophene etc.)
organic molecules promoting the octane number (methyl-tertiary-butylether etc)
dioxins
heterocyclic compounds (medicines, medicine components etc.)
pesticides, fungicides, herbicides
cyano compounds

Of course the technology can be used as a combination of other methods.

Another advantage of the technology is that not only the upper layers of the ground, but the lower layers can be treated, thus remediation can be done in a way that the upper layers aren't touched.
(ii) If genetically non-modified microorganisms are isolated from the environment for bioremediation, so called sterile “solid minimal cultural-media” or preferably “silicagel solid culture-media” is used. (for example in Petri-dishes)

Whether we isolate microorganisms capable of both aerobic and anoxic activity it is advised to use culture-media containing nitrogen, sulphur, phosphorous salts and agar-agar, preferably sterile silicagel solid culture-media.

It is important to administer the specific hydrophobic pollutant or other hydrophobic compounds (hydrocarbons, rock-oil, or its components and their derivatives) to decompose, dissolved in some kind of solvent, for instance a certain volatile organic solvent (alcohol, acetone, ether), preferably in pentane, hexane, or in methyl-benzene in the form of a thin film. Then the selected microorganisms from a fresh culture should be streaked onto this pollution layer, afterwards it should be incubated in the appropriate conditions for the strains (psychrophil, mesophil, thermophil, and aerobic, or anaerobic). After a certain time the microorganisms resistant to the pollutant and are able to decompose it will form colonies usually consistent or showing characteristic morphology or pigmentation.

The microorganisms release enzymes into the area around the colonies, which are capable of decomposing the hydrophobic compounds such as hydrocarbons, and tensides are released, too. (FIG. 1. and 2.)

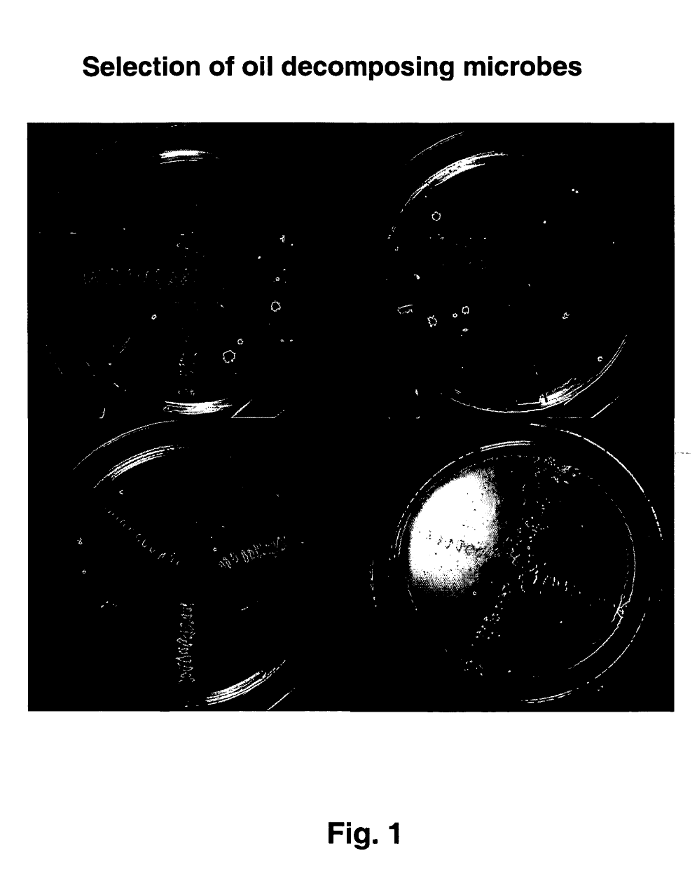

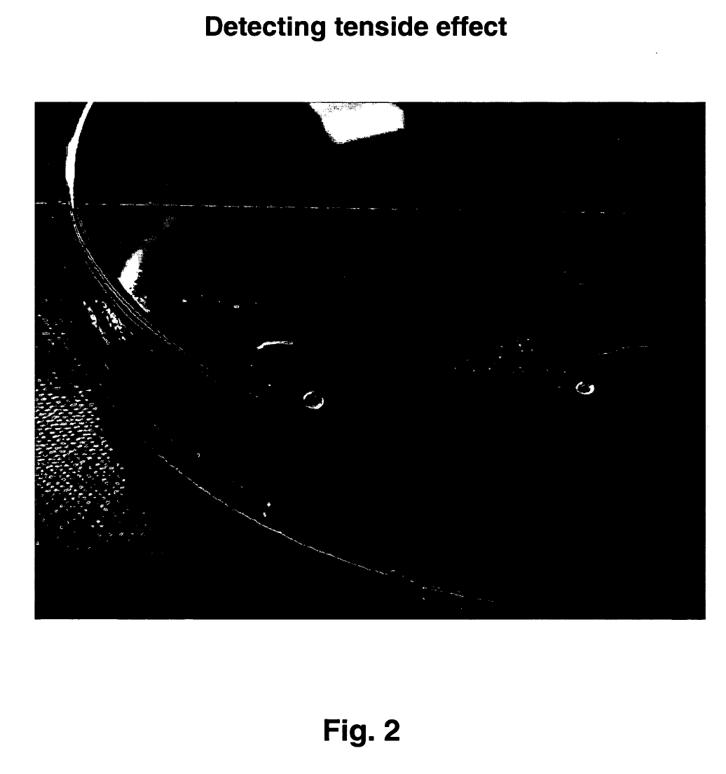

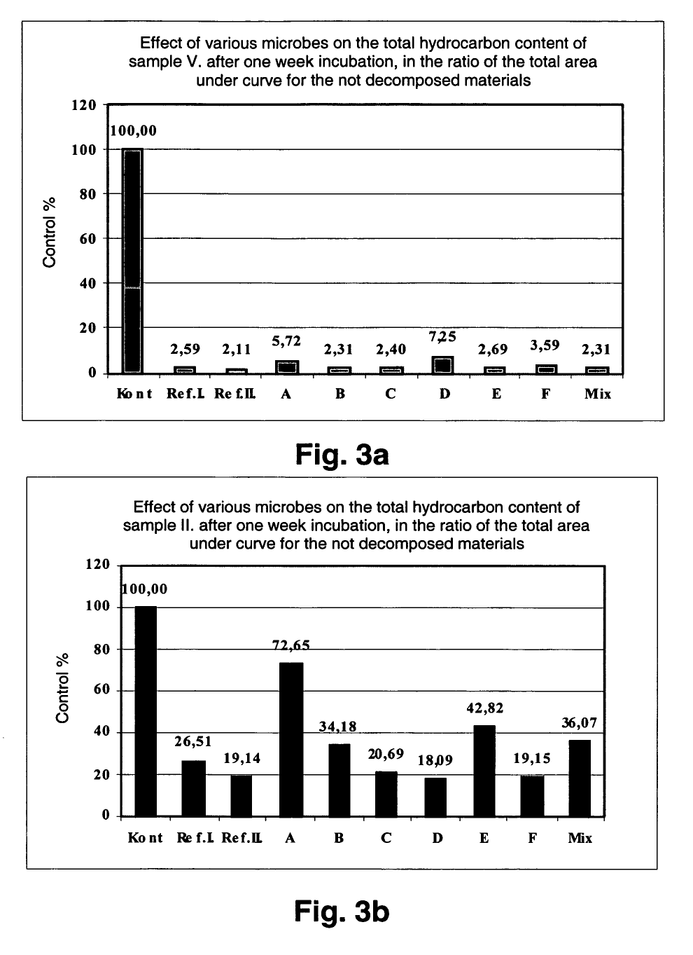

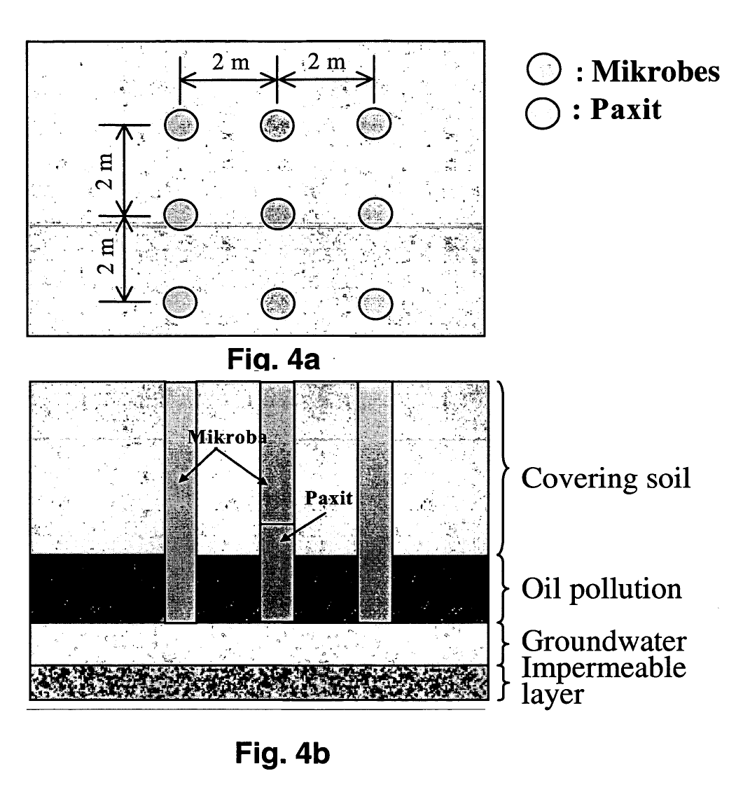

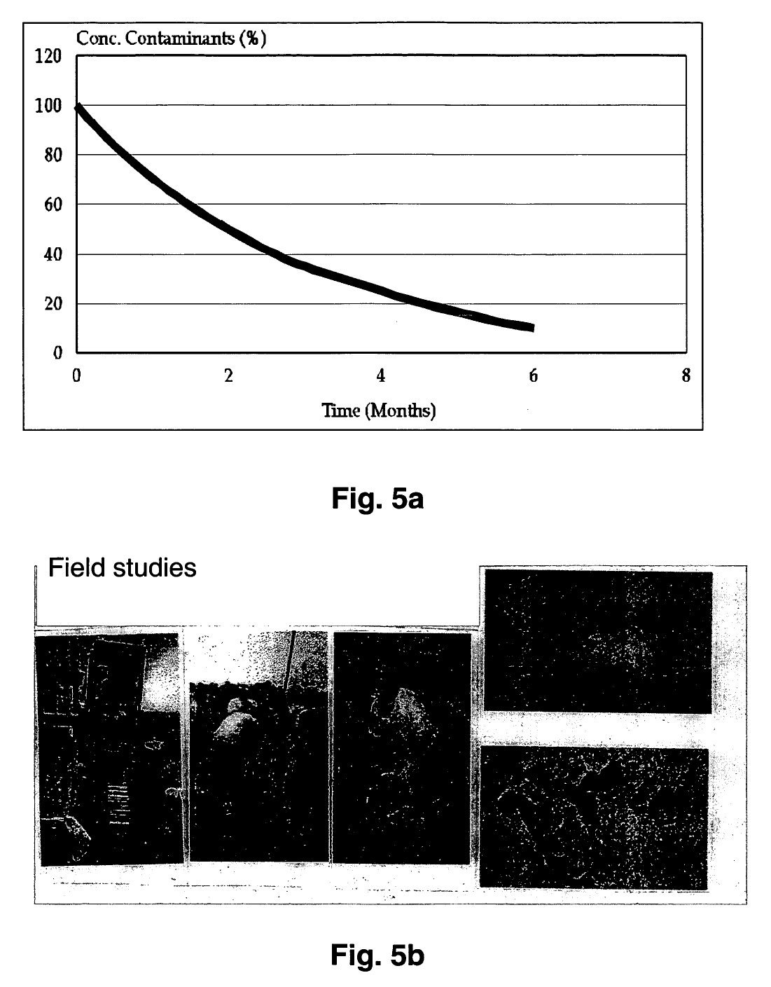

The enzyme production can be characterized by the width of the band (clearing up or discoloration) surrounding the colonies. This characterizes the intensity of the enzyme production mainly (FIG. 1.). The produced enzyme activity can be determined by taking samples from the surrounding area of the colonies and we determine the composition of the pollutant by the means of gas chromatography. (FIG. 3a and 3b) The microorganisms showing the highest enzyme activity are then selected.

The microorganisms producing tensides can be selected according to the hydrophilic-hydrophobic examination. (for instance by water drops then by paraffin drops; see FIG. 2).

Depending on the conditions of the selection of the microorganisms we can acquire information concerning their essential conditions besides their activity of decomposition. Thus microorganisms used for bioremediation can be ones that prefer cold (psychrophilic), the ones that prefer medium temperature (mesophilic), or the ones that prefer temperature above normal (thermophilic).

Considering their oxygen needs aerobic, anaerobic, and facultative anaerobic microorganisms can be acquired. In bioremediation mesophilic-aerobic, thermophilic-anaerobic, and facultative anaerobic microorganisms should be used, because they exceed the others in effectiveness and rentability. Facultative anaerobic microorganisms are preferable. For their selection, besides the requirements postulated, (such as the culture-media should contain compounds promoting anoxic respiration) it is also important that the colonies be incubated in anaerobic conditions.

In certain cases there can be a demand that the microorganisms used for bioremediation be apathogenic (1, 2), in other words they should cause neither plant, nor animal, nor human diseases. In other cases even microorganisms capable of causing diseases can be used, if later on they die or if they have no effect on humans, thus can be used as a pesticide or herbicide at the same time.

Using the above-mentioned selection method the inventors isolated Bacillus subtilis, Bacillus cereus, Pseudomonas sp. and Xanthomonas sp. microorganisms from oil polluted soils, the following of which were deposited on Apr. 17, 2002 at the National Collection of Agricultural and Industrial Microorganisms in Budapest according to the Budapest Treaty:

| MOL-number | Deposition number |
|---|---|
| MOL-2 | NCAIM (P) B 1304 |
| MOL-32 | NCAIM (P) B 1305 |
| MOL-51 | NCAIM (P) B 1306 |
| MOL-66 | NCAIM (P) B 1307 |
| MOL-107 | NCAIM (P) B 1308 |

Microorganisms can be genetically modified, favorably carrying DNA fragment—of which the sequence is known—ligated into its' genomes as a marker.

During the selection of the facultative anaerobic microorganisms we can use the following compounds, for instance electron acceptors and hydrogen acceptors, which allow anoxic respiration such as nitrite (NO₂⁻), nitrate (NO₃⁻), chlorite (ClO₂⁻), phosphate (PO₄³⁻) or sulphate (SO₄²⁻) etc. salts, furthermore inorganic salts of other compounds, which also help anoxic respiration (NO₂, NO₃, PO₃, PO₄, P₂O₄, P₂O₇, ClO₄, organic compounds can be used.

A favorable solution can be to add electron acceptor additives which catalyze inorganic respiration such as metal ions and their salts, preferably Zn²⁺ ions or Ti²⁺ ions for instance in the form of TiCl₂ salt.

During the selection, while choosing the additives we have to take the quality of the environment and its composition into consideration in which we want to apply the microorganism.

If the environment to be treated is soil; for instance in the substratum, the anions that contain N and P are rare, while the ones that contain S (SO₄²⁻) and cations such as K⁺ and Ca²⁺ aren't. It is also important to provide ions for the bacteria, which though rare to be found in the soil are vital for the catalytic function of enzymes, for instance Mn-, Mo-, Ti- and Zn-ions.

Several of the additives, which improve the activity of microorganisms isolated with our selection method for bioexplosions are summarized Table 1 above.

It is evident that the additives should be added to the soil in a concentration that isn't toxic to the microorganisms.

### EXAMPLES

### Example 1

Cultures on Minimal Medium

Suspensions (1-20%) of soil samples containing pollutants (rock-oil components, paraffins, asphaltenes, maltenes, etc, or derivatives of the rock oil) dispersed in physiological salt solution or even in any physiologically useable buffer with a pH 6.5-7.6 were made. Certain dilutions of such suspensions were administered onto the surface of agar-agar minimal culture-media, and were incubated at 0-80° C. for random time, preferably for 12-72 hours. The isolated colonies were selected according to their activity of pollutant decomposition.

Agar-agar minimal culture-media (for 1000 g of distilled water):

0.1-3 g preferably 2.5 g Na₂HPO₄
0.1-3 g preferably 1.5 g KH₂PO₄
0.1-3 g preferably 0.5 g (NH₄)₂SO₄
0.01-3 g preferably 0.05 g CaCl₂
0.5-3 g preferably 2.0 g agar-agar
0.1-5 g preferably 1.5 g NaNO₃

It can be seen that the media contains ions promoting anoxic respiration (PO₄³⁻ and its protonated forms, SO₄²⁻, NO₃⁻) in other words it contains electron acceptors, which also allows the selection of aerobic and facultative aerobic microorganisms.

In certain cases the aforementioned media was supplemented with 50 mL sometimes 10 mL of the following solution (1000 mL):
0.1-0.5 g preferably 0.25 g H₃BO₄
0.1-1.0 g preferably 0.25 g CoCl
0.1-2.0 g preferably 0.25 g CuCl₂
0.05-2.0 g preferably 0.25 g FeSO₄
0.01-1.0 g preferably 0.025 g MnCl₂
0.01-1.0 g preferably 0.025 g NaMoO₄
0.01-1.0 g preferably 0.025 g NiCl₂
0.01-1.0 g preferably 0.025 g TiCl₄

The metal ions of other oxidative states (for example Ti, Mn, Mo ions) also promote anoxic respiration as redox systems.

### Example 2

Silicagel Culture-media

The microflora of the polluted soil samples can be grown on so called “silicagel minimal culture-media” which is a version of Vinogradszkij type silicagel solid culture-media (12), which is supplemented with the compounds mentioned in Example 1.

Thermophilic (50-80° C.) and extreme thermophilic (80-110° C.) microorganisms can be grown and selected on silicagel minimal culture-media.

### Example 3

Examination of the Activity of Pollutant Decomposition

The ability of decomposition of the microorganisms isolated from minimal culture-media can also be examined on such solid media. In this case we administer the hydrophobic pollutant (hydrocarbons, lipoids etc.), dissolved in some kind of solvent, for instance a certain volatile organic solvent (alcohol, acetone, ether), preferably in pentane, hexane, in the form of a thin film. Then the microorganisms to be examined should be streaked onto this pollution layer. (FIG. 1)

The colonies are incubated at the desired temperature with the given oxygen concentration, for a desired time, preferably for 12-96 hours, more suitably for 48 hours, then the method should be repeated preferably 2-3 times again with the cultures grown.

The controlled level of oxygen concentration allows us to perform our method in aerobic and anoxic conditions, thus we can isolate microorganisms which show activity in both aerobic and anoxic conditions. During the isolation of such facultative anaerobic microorganisms, part of the growth was done in anoxic conditions, and the media contained compounds that promote anoxic respiration.

When the microorganisms isolated in the aforementioned way were streaked onto the film of pollutant, in the area around the colonies clearing up and discoloration could be observed showing that the pollutant was either converted, or decomposed. (FIG. 1)

Below we will introduce how we examined the effectiveness of decomposition, the ratio of pollutants decomposed after a certain time in the clearing (FIG. 2), thus the selected enzymes' activity was examined. Also we could examine the appearance of other compounds, specifically tensides, during the course of decomposition, which helped the process. (FIG. 2)

Of course an expert can use other protocols in this case.

### Example 4

Examination of the Effect of Microorganisms

The Activity of Enzymes of Oil Decomposition

On the surface of 15 mL of minimal agar-agar or minimal silicagel culture-media in a sterile Petri-dish with a 10 cm diameter we administered a thin film of pollutant (rock oil products dissolved in 5% hexane or methyl-benzene solutions). Onto this film with a platinum loop we streaked the microorganisms isolated from a polluted environment (soil, ground water, etc), and grown in liquid media. Then they were incubated under the desired conditions (aerobic, or anaerobic), at the chosen temperature (15-20, 30-35 or 50-85° C.) for the desired time (24-240 hours), up until the microorganisms formed distinguishable colonies. In case we can observe a certain change in the hydrocarbon film (clearing, discoloration) we take samples from these zones, then extract it (hexane, methyl-benzene etc) with a solvent, then we examine the rock oil product's quantity and its composition with the help of gas chromatography.

The effectiveness the production (also including the viability) of enzymes capable of decomposing oil can be characterized by the width of the zone of clearing. The activity of the enzymes can be followed by the decrease of the quantity of hydrocarbon components of the rock oil products.

The activity of a few of the isolated microorganism strains is compared to other known strains (Table 2, 3). The letters in the table mean the following:

| | | |
|---|---|---|
| Ref I | Hegrem* | |
| Ref II | Hegboost* | |
| A | MOL-2 | NCAIM (P) B 1304 |
| B | MOL-32 | NCAIM (P) B 1305 |
| C | MOL-51 | NCAIM (P) B 1306 |
| D | MOL-66 | NCAIM (P) B 1307 |
| E | MOL-107 | NCAIM (P) B 1308 |
| F | MOL-113 | A Pseudomonas sp. strain |
| | | isolated by the inventors |

*commercialized by Oil Cleaning Bio-Products Ltd. P.O.Box 46, Royston, Hertfordshire SG8 9PD U.K., see also the product descriptions and the home page: www.ocbp.co.uk.

TABLE 2
The effect of bacteria groups on paraffins
with different melting points.

| Sign of | paraffin | | | | |
|---|---|---|---|---|---|
| group | DW 6266 | DW 7580 | DW 5456 | DW 5658 | DW 5052 |
| BO-1^{e} | + | + | + | + | + |
| | 6 | 5 | 6 | 6-8 | 4-7 |
| RO-1^{e} | + | + | ++ | + | ++ |
| | 6 | 6 | 4-11 | 3-6 | 5-12 |
| A^{t} | ++++ | + | +++ | ++++ | +++ |
| | 15-18 | 5-8 | 10-15 | 11-19 | 11-16 |
| B^{t} | +++ | + | +++ | ++++ | +++ |
| | 5-11 | 5-6 | 10-15 | 13-20 | 10-16 |
| C^{t} | +++ | ± | +++ | +++ | +++ |
| | 10-15 | 4 | 14-17 | 14-18 | 11-14 |
| D^{e(t)} | + | + | ++++ | ++++ | + |
| | 5-7 | 4-5 | 10-22 | 10-34 | 4-7 |
| E^{e(t)} | + | +++ | +++ | +++ | +++ |
| | 6-7 | 10-13 | 13-17 | 11-13 | 13-16 |
| F^{e(t)} | ++ | ++ | ++ | ++ | ++ |
| | 9-12 | 6-10 | 7-12 | 4-10 | 7-12 |

^{t}effect of tensides
^{e}enzyme activity
activity
+ insignificant
++ partial
+++ satisfactory
++++ outstanding
number - the diameter of the decomposed area

TABLE 3
Different precipitated rock oil decomposition with
bacteria groups at 37° C. after 96 hours.

| | | | | 5% asphaltene + Alg |
|---|---|---|---|---|
| Sign | hydrophobic^{x} | asphaltene | maltene | #571 oil |
| BO-1 | + | | + | ++ |
| | 4-7 | 9 | 4-7 | 6-12 |
| RO-1 | + | | + | ++++ |
| | 4-10 | 7 | 4-8 | 15-18 |
| A | + | ++++ | ± | ++++ |
| | 5 | 10-38 | 2 | 22-25 |
| B | + | ++++ | + | ++++ |
| | 4-8 | 14-20 | 4-7 | 34-37 |
| C | + | ++ | ± | ++++ |
| | 4-6 | 7-12 | 2-4 | 25-30 |
| D | + | + | + | ++++ |
| | 3-6 | 4 | 4-8 | 30-35 |
| E | ++++ | + | ++++ | ++++ |
| | 22-25 | 5-7 | 20-25 | 30-35 |
| F | + | + | ++++ | |
| | 4-5 | 4-5 | 10-35 | 20-35 |

t-effect of tensides
e—enzyme activity
activity
+ insignificant
++ partial
+++ satisfactory
++++ outstanding
number - the diameter of the decomposed area

While comparing the FIG. 3 with the Tables one can see that the enzyme activity (measured with gas chromatography, i.e. GC) of our isolated strains was a match for the strains known up to date, the effectiveness of decomposition (characterized by the average width of the area cleared up as a band), considering the pollutant significantly exceeded that of the strains known up to date. In case of the Hegrem and Hegboost products we weren't able to detect any production of tensides. With our technology microorganisms specifically selected can be produced and can be used specifically for a pollutant that they decompose the most effectively.

The Detection of Tensides Produced with the Help of Hydrophilic-hydrophobic Drops

We repeat the procedure mentioned in Example 4 in case of the oil decomposing enzymes, with the exception that in the clearing surrounding the colonies of the chosen microorganisms, under the desired conditions we administer a few drops of distilled water or melted paraffin onto the surface of the media. In the zone containing tensides the drop of distilled water spreads out, while in the area with no clearing up (hydrophobic) it forms a moveable bead like drop. The melted paraffin drop spreads out in a moveable manner in the area with tensides, while it sticks to the hydrophobic zone making its movement impossible. (FIG. 2)

The surface critical angle of the drops is measurable, and can even be used to quantitively describe the production of tensides if fixing other parameters. (growth time, drop zone).

### Example 5

Method of Bioremediation

We administer a mixture of microorganisms of B. cereus, B. subtilis, and Pseudonomas sp. group isolated as mentioned in Examples 1-4 in an equivalent ratio and in satisfactory amount, preferably in a concentration of 10⁴-10¹², suitably 10¹¹ microorganisms per kg of contaminated soil, to the polluted medium in a way that after desired distances (0.5-6 m, preferably 1.5-2 m) and to a given depth (to the level of ground water) we drill holes. The holes are drilled in the corners of a square, into one of these holes we place the microorganisms, then we place the additives and nutrition into another hole, and in the rest of the holes we place the explosives (FIG. 4) in a symmetrical manner. Then follows the bioexplosion (FIG. 5b)

After the bioexplosion we leave the soil undisturbed for 1-120 days, preferably 5-6 days, then comes the subsequent treatment (aeration, infiltration, injection, steaming, etc.).

The decomposition of a rock-oil pollution of 40-60 g/kg concentration at 4-6 m underground after a bioexplosion without subsequent treatment can be seen in FIG. 5a.

The same pollution was produced (ex situ) and mixed together (with a prism) with the soil, and was cleansed with the same quality and quantity of microorganisms and additives used in the in situ bioexplosion.

The specific cost of the two methods according to our calculations:
Ex situ (prism) method: 40-60 USD/tons
In situ (bioexplosion) method: 8-16 USD/tons

According to our experiences the bioexplosion technology's costs are competitive with other prism-remediation technologies, while the effectiveness exceeds them.

Execution of the Detonation

We first survey the location, then the horizontal and vertical extent of the pollution of the soil. Afterwards holes are drilled into the ground in the desired distance, diameter, depth, in a quadratic manner, all the way down to the ground water level. We place the explosives of the desired quality (such as paxite, etc) and in the desired quantity into a plastic tube, which is lowered into every uneven numbered hole. Thus we can achieve the desired detonation effect. (FIG. 4)

The explosives are connected to an electric fuse, and the wires are connected in parallel so the detonation can be simultaneous or in desired portions. (FIG. 3b)

In the following the desired amount of additives are dissolved in water, then placed in plastic tubes, which are then placed in the even holes, either above the explosives or in empty ones. The microorganisms also placed in plastic tubes, should also be placed in the empty even numbered holes.

At last the additives and microorganisms can be bioexploded, the strength of the detonation should be chosen to achieve maximum mixing of the microorganisms and additives without allowing them to the surface.

### Example 6

Procedure of Aeration

Down to the level of the ground water we place metal tubes in a quadratic formation into the polluted ground loosened by the explosion. At a selected part of the tubes (third, or fourth of the length) we drill a desired number of holes with the right diameters. With the help of a compressor we can administer oxygen, water vapor, or with a pump we can administer new portions of additives and/or compounds promoting the decomposition of the pollutant.

### Example 7

Application

The technology can be used to cleanse polluted soil, ground water, trash dumps of rock oil, grease, fuels, other hydrocarbons, and derivatives (halogenated), or of pesticides, herbicides, toxic wastes, or of usually biologically decomposable/neutralizeable xenobiotics. The use of this technology can be confined within limits. In populated areas or gas stations the use of the technology is prohibited or limited.

In addition our technology can be used to moderate the effect of environmental catastrophes causing ground contamination (outburst of natural gas and thermal water etc.), the effect of serious soil pollutions (such as pipeline deficiency, cyan pollution etc.), or the effect of polluted floods, inland waters, waste-piles etc, and to try to cleanse the ones that are situated between the surface and the ground water level. In certain cases it can also be used against pollutants, which have already reached the ground water.

Cited Literature

1.) Oil Cleaning Bio-products Ltd., Press release on Hegrem bacteria
2.) Oil Cleaning Bio-products Ltd., Press release on Hegboost bacteria
3.) Thomas J. M. and Ward C. H. (1989), Environ. Sci. Technol. 23:760-766.
4.) Van der Meer et al. (1992), Microbiol. Rev. 56:677-694.
5.) Kopp-Holtwiesche B. et al. (1992), Biotech. Forum Europe No. 6.
6.) Sloan R. (1987), Oil and Gas J. 61-66.
7.) Bouwer E. J. and Zehnder A, J. B. (1993) TIBTECH 11:360-367.
8.) Plumb R. H. J. (1991), Groundwater monitoring Rev. 11:157-164.
9.) Rijnarts H. H. et al. (1990), Environ.Sci.Technol. 24:1349-1354.
10.) Bouwer E. J. and Ward C. H. (1989), Environ Sci. Technol. 23:760-766
11.) Bergey's Manual of Systematic Bacteriology Vol. 1 (1984)
12.) A. S. Dietz, A. A. Yayanos, Appl. Environm. Microbiol. 36:966 (1978)

1. A process for decreasing the degree of the pollution comprising the steps of
(i) placing in the polluted soil or close to it, below the surface of the soil
microorganisms useful for decomposing or inactivating at least one kind of material causing pollution, said microorganisms being, if desired, resistant to said material, and
an explosive
(ii) mixing the polluted soil and the microorganisms by explosion, whereby the soil treated is loosened and
(iii) allowing the microorganisms to act in the soil.

2. The process of claim 1 wherein in step (i) also additive materials improving living conditions of microorganisms and/or facilitating their propagation and/or soil-improving function are placed below the surface of the soil, and in step (ii) said additive materials are also mixed with the microorganisms and the polluted soil.

3. The process according to claim 1 or 2 wherein the microorganisms, explosive and optionally further additive materials are placed in holes bored in soil.

4. The process according to claim 3 wherein the microorganisms and the explosive are placed in separate holes.

5. The process according to claim 3 wherein the microorganisms and the explosive are placed in the same holes above each other, preferably the explosive being placed below the microorganisms.

6. The process according to any of claims 3 to 5 wherein the microorganisms, the explosive and preferably the additive materials are placed in plastic tubes which are then placed in the holes.

7. The process according to any of claims 2 to 6 wherein after the explosion additives improving living conditions of the microorganisms and/or facilitating decomposition are introduced into the soil, for instance by aeration, infiltration or injection, wherein preferably one or more of the following are applied:
compounds promoting anoxic respiration, metal ions, trace elements, carbon sources, nitrogen sources, phosphorous sources, sulphur sources tensides and/or surfactants, compounds promoting adhesion to surface.

8. The process according to any of claims 3 to 6 wherein the holes are at a distance of 0.5 to 5 m from each other and the strength of explosion is set to a value which results in the damage of at most a small part of microorganism, more preferably in no damage and no uncovering of the microorganisms.

9. The process according to any of claims 1 to 8 wherein the pollutant is a mineral oil component or derivative.

10. A method for preparing a facultative anaerobic microorganism in an isolated form, said microorganism being useful for decomposing a hydrophobic pollutant comprising a mineral oil component or derivative thereof during soil remediation capable of exerting its decomposing activity at the boundary of the hydrophobic phase comprising the said hydrophobic pollutant, mineral oil component or derivative and a hvdrophilic phase, the process comprising the steps of
i) applying a film comprising said hydrophobic pollutant to a minimal medium lacking carbon source,
ii) inoculating this medium with a sample comprising a mixture of microorganisms said sample being obtained from an oil pollution, and incubating the medium after inoculation at least until detectable microorganism colonies are formed,
if the formation of colonies does not occur within an arbitrarily defined time period step i) and present step ii) are repeated,
iii) decomposing activities of the microorganism from the colonies formed are tested at the surround of the colonies and
iv) tenside producing abilities of the decomposing microorganisms obtained from the colonies are checked and a tenside producing microorganism is selected,
wherein the minimal medium comprises materials facilitating anoxic respiration, preferably electron acceptors and/or oxygen sources—in particular one or more of the following: Ti-compounds, Mn-compounds, nitrite, nitrate, phosphate, pyrophosphate ions or their salts, and
wherein the incubation is carried out at least partly under anaerobic conditions.

11. The method according to claim 9 or 10 wherein the tenside producing ability of the microorganisms from the colonies obtained is be studied by a hydrophobic-hydrophilic drop test.

12. The method according to claim 9 or 10, wherein the decomposing activity is assessed by assaying the pollutant concentration of samples taken from the close surround or immediate vicinity of the colonies and/or on the basis of the diameter of the decomposed area.

13. The method of claim 12 wherein as a decomposing activity paraffin decomposing activity is assayed or an enzyme activity for decomposing typical mineral oil pollutions, preferably by sampling, solvent extraction and then by gas chromatography.

14. Use of a facultative anaerobic microorganism of the Pseudomonas genus for decomposing a hydrophobic soil pollutant comprising mineral oil component or derivative during soil remediation, said microorganism producing at least one enzyme capable of decomposing the mineral oil component or derivative, and at least one tenside.

15. Use of a facultative anaerobic microorganism of the Pseudomonas genus, said microorganism producing at least one enzyme capable of decomposing the mineral oil component or derivative, and at least one tenside,
for decomposing a hydrophobic soil pollutant comprising mineral oil component or derivative during soil remediation by any of the methods according to claims 1 to 9.

16. The use of any of claims 14 to 15 wherein the oil-pollutant decomposing activity of the microorganism, detected by culturing on a polluted medium on any of the following oil-pollutants: hydrophobic deposit, asphaltene, maltene, 5% asphaltene plus oil, is at least 1.5 times larger, as an average, than that of the Hegrem or Hegboost microorganism.

17. The use of any of claims 14 to 17 wherein the microorganism is any of the following microorganisms deposited on Apr. 17, 2002 at the NCAIM: NCAIM (P) B 1304, NCAIM (P) B 1305, NCAIM (P) B 1306, NCAIM (P) B 1307, NCAIM (P) B 1308, or any strain derived therefrom.

18. A facultative anaerobic microorganism of the Pseudomonas genus obtainable by the method of any of claims 10 to 13, said microorganism producing at least one enzyme capable of decomposing the mineral oil component or derivative and at least one tenside, being capable of decomposing a mineral oil component or derivative during soil remediation.

19. The microorganism of claim 18 which is any of the following microorganisms deposited on Apr. 17, 2002 at the NCAIM: NCAIM (P) B 1304, NCAIM (P) B 1305, NCAIM (P) B 1306, NCAIM (P) B 1307, NCAIM (P) B 1308, or any strain derived therefrom.

20. The microorganism of any of claims 18 to 19 which is genetically modified preferably carries, incorporated into its genome, a DNA fragment of a known sequence.

21. Kit for decomposing a hydrophobic soil pollutant comprising mineral oil component or derivative during soil remediation comprising an information carrier with users instructions which comprise instructions for carrying out any of the steps of any of the processes of claims 1 to 9 and said kit further comprising at least one kind of material applicable in any of the processes of claims 1 to 9.

22. The kit of claim 21 comprising a microorganism as defined in any of claims 14 to 20.

23. The kit of claim 22 comprising on or more of the following group: explosives, aids to blasting, additives to ensure living conditions or helping microorganisms or increasing the effect thereof.

24. The kit of claim 23 comprising one or more of the following
compounds promoting anoxic respiration, metal ions, trace elements, carbon sources, nitrogen sources, phosphorous sources, sulphur sources tensides and/or surfactants, compounds promoting adhesion to surface.

25. The process according to claims 8 wherein the holes are at a distance of 1.5 to 2 m from each other.
